(19) United States
(12) Patent Application Publication
(10) Pub. No.: US 2018/0374146 A1
(43) Pub. Date: Dec. 27, 2018

(54) INTELLIGENT DEVICE ACCESSORY SHARING

(71) Applicant: Google LLC, Mountain View, CA (US)

(72) Inventor: Sudhanshu Rawal, Gurgaon (IN)

(21) Appl. No.: 14/937,692

(22) Filed: Nov. 10, 2015

(51) Int. Cl. G06Q 30/06; G06Q 10/02

(52) U.S. Cl. CPC G06Q 30/0645; G06Q 10/02

(57) ABSTRACT

This document describes intelligent device accessory sharing system. When desiring to borrow a device accessory, a borrower device sends an enquiry to potential lender devices, the enquiry identifying the desired device accessory and optionally compatibility details for the device accessory (e.g., driver information for the device accessory installed on the borrower device). Each potential lender device receives the enquiry and automatically determines whether a user of the potential lender device has the device accessory and/or whether the device accessory is available for lending by the potential lender. Based on these determinations, each potential lender device returns an indication to the borrower device of whether the device accessory can be borrowed from the potential lender, and the borrower device displays or otherwise presents indications to the borrower of the potential lenders from which the device accessory can be borrowed.

### BACKGROUND

Computers are commonplace and used in many aspects of our lives. Oftentimes users desire to couple device accessories to their computers, such as Web cams, headphones, phone chargers, and so forth. However, situations arise in which users lack a device accessory that they want. For example, the user may not currently have a Web cam with him or her but desires to use one for an upcoming video conference. The user can walk around the apartment building or office or send email messages to friends or coworkers asking if they have the device accessory that the user can borrow. This asking, however, is a cumbersome process that can be time-consuming for the user and bothersome to the user's friends or coworkers.

### SUMMARY

This document describes, in accordance with one or more aspects, a method in a computing device including determining that a device accessory is desired at the computing device, and generating a first list of potential lenders based at least in part on a location of the computing device and locations associated with potential lenders. The method further includes communicating, for each potential lender on the first list, an enquiry to a device of the potential lender, the enquiry identifying the device accessory, and receiving, from at least one of the potential lender devices, an indication of whether the device accessory can be borrowed from the potential lender. The method also includes generating a second list of potential lenders based at least in part on the received at least one indication, and presenting, at the computing device, an identifier of at least one of the potential lenders on the second list.

This document also describes, in accordance with one or more additional aspects, a method in a computing device including receiving an enquiry from a borrower device, the enquiry identifying a device accessory desired by the borrower device, and automatically determining, in response to the enquiry, one or both of whether a user of the computing device has the device accessory and whether the device accessory is available for lending by the user. The method further includes transmitting, to the borrower device, an indication that the device accessory can be borrowed from the user in response to determining that the user has the device accessory and that the device accessory is available for lending by the user.

This summary is provided to introduce simplified concepts concerning the techniques, which are further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and devices for intelligent device accessory sharing are described with reference to the following drawings. The same numbers are used throughout the drawings to reference like features and components:

FIG. 1 illustrates an example environment employing intelligent device accessory sharing in accordance with one or more embodiments.

FIG. 2 illustrates an example borrower device in accordance with one or more embodiments.

FIG. 3 illustrates an example user interface allowing user input to select a device accessory.

FIG. 4 illustrates another example user interface allowing user input to select a device accessory.

FIG. 5 illustrates an example user interface displaying names of potential lenders from which the desired device accessory can be borrowed.

FIG. 6 illustrates an example potential lender device in accordance with one or more embodiments.

FIG. 7 depicts a method, which describes operation of a borrower device in accordance with one or more embodiments.

FIG. 8 depicts a method, which describes operation of a potential lender device in accordance with one or more embodiments.

FIG. 9 illustrates an example computing system embodying, or in which techniques may be implemented that enable use of, the techniques discussed herein.

### DETAILED DESCRIPTION

Overview

This document describes techniques using, and devices enabling, intelligent device accessory sharing. Use of these techniques and devices facilitates the borrowing and lending of device accessories. A device accessory refers to a device or component that is coupled to a computing device, such as a Web cam, headphones, data cable, phone charger, and so forth. The techniques discussed herein allow a user (referred to as a borrower) of a device, when desiring to borrow a device accessory, to identify one or more other users (referred to as potential lenders) of other devices from which the device accessory can be borrowed. A borrower device refers to a device being used by a borrower desiring to borrow a device accessory, and a potential lender device refers to a device being used by a potential lender from which the device accessory can possibly be borrowed.

Generally, the borrower device determines that a user at the borrower device desires to borrow a device accessory. This determination can be automatic (e.g., based on upcoming calendar events) or in response to a user request for the device accessory. The borrower device generates a first list of potential lenders that are at the same general location as the borrower device, and communicates an enquiry to the device of each potential lender. The enquiry identifies the device accessory and optionally compatibility details of the device accessory (e.g., a type of the borrower device, an operating system running on the borrower device, driver information for the device accessory installed on the borrower device) and/or an anticipated time and duration of use of the device accessory by the borrower device.

Each potential lender device receives the enquiry from the borrower device identifying the desired device accessory. The potential lender device automatically determines whether a user of the potential lender device has the device accessory and/or whether the device accessory is available for lending by the potential lender. The potential lender device's automatic determination occurs without interaction with the potential lender. The device accessory may not be available for various reasons, such as due to the potential lender currently using the device accessory. The potential lender device returns to the borrower device an indication that the device accessory can be borrowed from the user in response to determining that the user has the device accessory and that the device accessory is available for lending by the user. The potential lender device optionally returns to the borrower device an indication that the device accessory cannot be borrowed from the user in response to determining that the user does not have the device accessory and/or that the device accessory is unavailable for lending by the user.

The borrower device receives the indications from the potential lender devices as to whether the device accessory can be borrowed from each of the potential lenders. The borrower device generates a second list of potential lenders that identifies the potential lenders from which the device accessory can be borrowed, and the borrower device displays or otherwise presents the second list of potential lenders. At this point, the borrower may interact interpersonally with one or more potential lenders presented in the second list by, for example, walking to the potential lender or sending the potential lender a message.

Thus, the communications between the borrower device and the potential lender devices allow potential lenders of the device accessory to be readily identified. The analysis performed by the potential lender devices further allow the borrower to know that the device accessory being borrowed is operable with the borrower device. For example, the borrower knows that the device accessory will work with the operating system running on the borrower device.

Thus, it can be seen that the sharing of a device accessory is done more intelligently. The borrower, when desiring to borrow device accessory, only contacts a person who has a high likelihood of having the device accessory and is not currently using the device accessory. The borrower does not disturb or interrupt other potential lenders with a request to borrow a device accessory that the other potential lenders do not have or are currently using. The determination of which potential lenders may have the desired device accessory is performed automatically by communications between the borrower device and the potential lender devices, and analysis of various state or information on the potential lender devices as discussed in more detail below.

### Example Environment

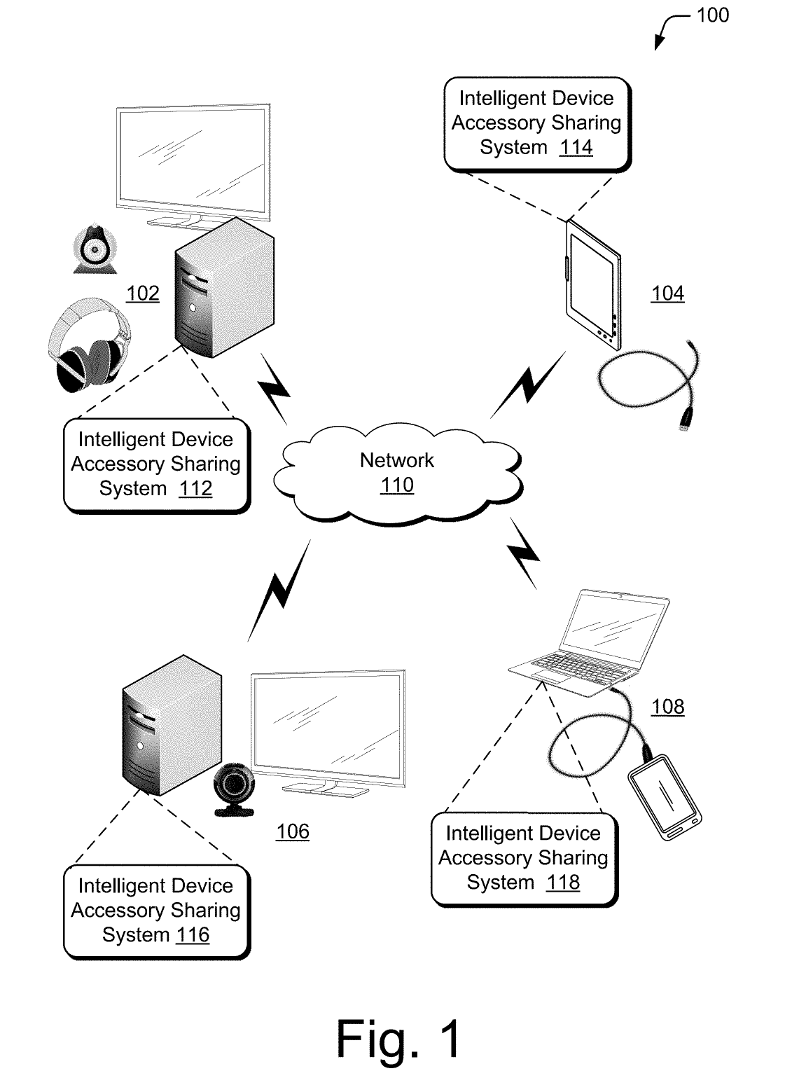

FIG. 1 illustrates an example system 100 employing intelligent device accessory sharing in accordance with one or more embodiments. The system 100 includes multiple computing devices 102, 104, 106, and 108 that can communicate with one another via a network 110. Network 110 can be a variety of different networks, including the Internet, a local area network (LAN), a phone network, an intranet, other public and/or proprietary networks, combinations thereof, and so forth. The network 110 can also include various direct couplings between individual computing devices, such as various wired and/or wireless communication couplings.

In the illustrated example of FIG. 1, the computing device 102 and the computing device 106 are both desktop computers, the computing device 104 is a tablet computer, and the computing device 108 is a laptop computer. It should be noted, however, that each computing device in the system 100 can be any of a variety of different types of devices. For example, each computing device in the system 100 can be a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth.

Each computing device also has one or more device accessories that the computing device uses. A device accessory refers to a physical component or product that couples to a computing device (via a wired and/or wireless connection) and provides additional functionality to the computing device. Device accessories are oftentimes input and/or output devices, such as Web cams, headphones, and so forth. For example, the computing device 102 has a Web cam and headphones device accessories, the computing device 104 has a data cable device accessory, the computing device 106 has a Web cam device accessory, and the computing device 108 has a cell phone charger device accessory. Although system 100 illustrates specific examples of device accessories, any of a variety of different device accessories can be associated with a computing device. Additional examples of device accessories include pen drives, thumb drives, laptop chargers, keyboards, mice or other cursor control products, and so forth.

In one or more embodiments, each computing device in the system 100 can be a borrower device or a potential lender device. Alternatively, in some situations a computing device may be only a borrower device or only a potential lender device. Generally, a user of a borrower device can request to borrow a particular device accessory from a user of a potential lender device. For example, the user of the computing device 108 may have an upcoming video conference and desire to borrow a Web cam, or the user of the computing device 102 may have a cell phone (not shown) running low on power and desire to borrow a charger to charge his or her cell phone.

Each computing device in the system 100 includes an intelligent device accessory sharing system. For example, the computing device includes an intelligent device accessory sharing system 112, the computing device 104 includes an intelligent device accessory sharing system 114, the computing device 106 includes an intelligent device accessory sharing system 116, and the computing device 108 includes an intelligent device accessory sharing system 118. Each of the intelligent device accessory sharing systems 112, 114, 116, and 118 provides functionality allowing the computing device that includes the intelligent device accessory sharing system to operate as a borrower device and/or a potential lender device as discussed herein.

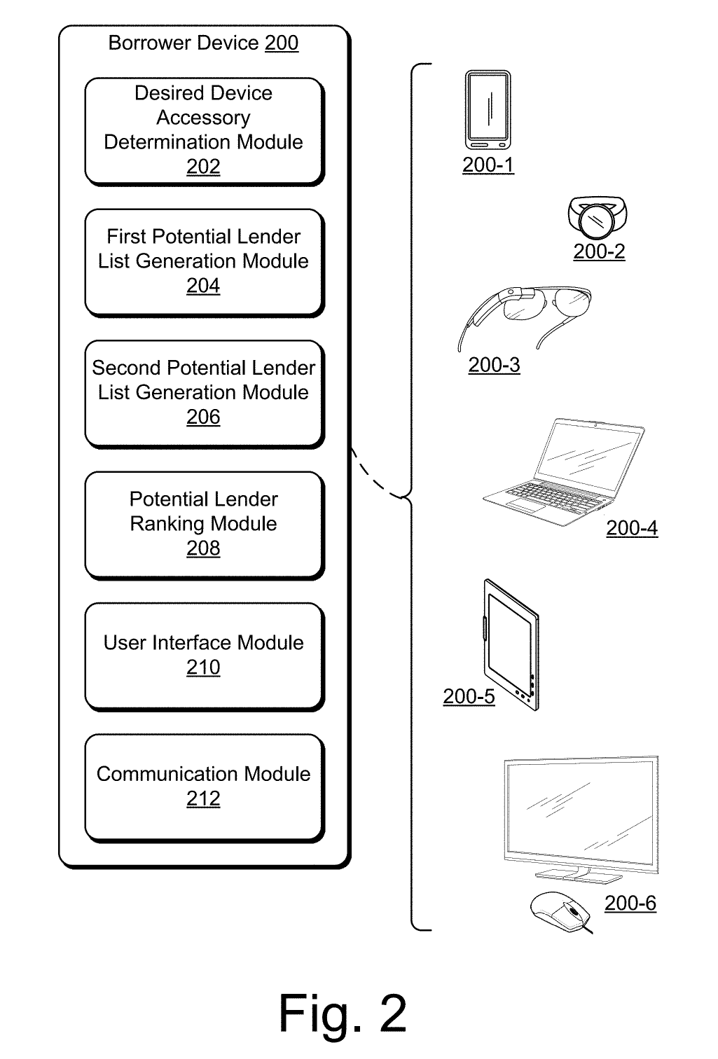

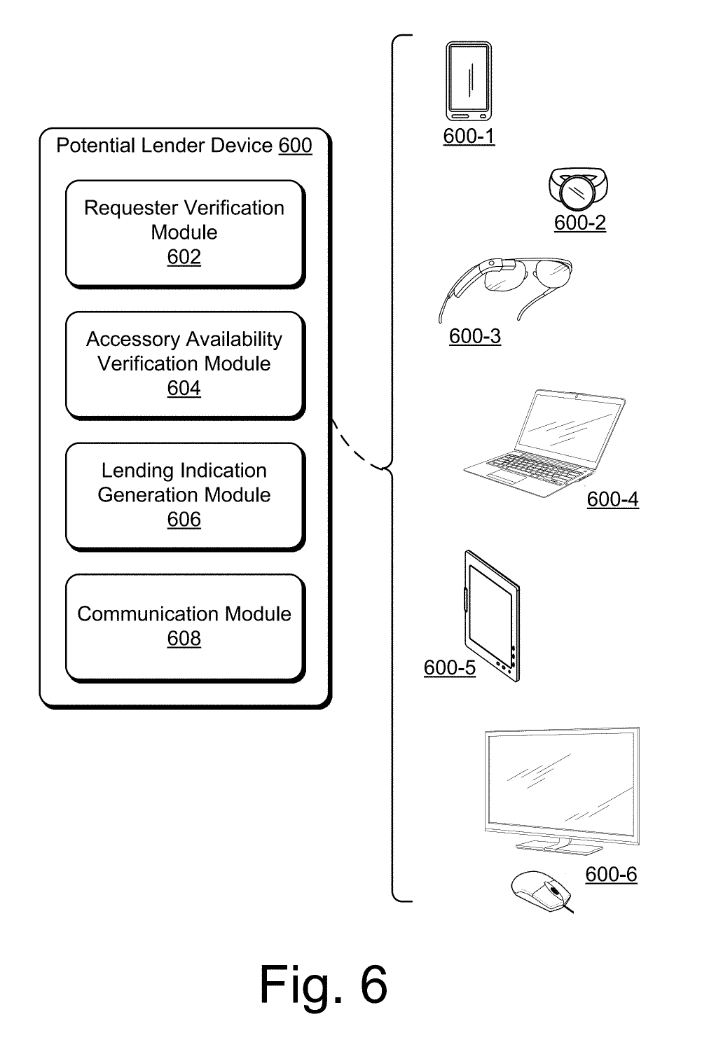

The operation of a borrower device is discussed in additional detail below with reference to FIG. 2. The operation of a potential lender device is discussed in additional detail below with reference to FIG. 6.

FIG. 2 illustrates an example borrower device 200 in accordance with one or more embodiments. The borrower device 200 can be, for example, any of the computing devices 102, 104, 106, 108 of FIG. 1. The borrower device 200 is illustrated as being one of a smartphone 200-1, a computing watch 200-2 sometimes called a smartwatch, computing spectacles 200-3, a laptop 200-4, a tablet computer 200-5, and a desktop with a mouse 200-6, although the borrower device 200 can be other types of computing devices as discussed above.

The borrower device 200 includes a desired device accessory determination module 202, a first potential lender list generation module 204, a second potential lender list generation module 206, a potential lender ranking module 208, a user interface (UI) module 210, and a communication module 212. The modules 202, 204, 206, 208 (and optionally the modules 210 and 212) together make up an intelligent device accessory sharing system of the borrower device 200.

The user interface module 210 presents a UI allowing a user to interact with the borrower device 200. The UI can receive inputs from various different input devices, such as microphones, keyboards, cursor control devices, touch screens, and so forth. The UI can also output information or data by displaying the information or data on a screen or otherwise presenting the information or data (e.g., playing back the information or data audibly). In the discussions herein, reference is made to various user selections (e.g., of a button, of a device accessory, etc.). It should be noted that these user selections can be made in any of a variety of different manners, such as clicking on a displayed name or button using a mouse or other cursor control device, touching the displayed name or button (in situations in which the list is displayed on a touchscreen), audible inputs such as “select borrow button” or “select Web cam”, and so forth.

The communication module 212 provides functionality allowing the borrower device 200 to communicate with other devices, such as potential lender devices. The communication module 212 can support communication over various types of networks via a transceiver of the borrower device 200, including direct wired and/or wireless communication couplings, as discussed above.

The desired device accessory determination module 202 determines when the borrower desires to borrow a device accessory. The desired device accessory determination module 202 can make this determination in a variety of different manners, such as in response to a user request to borrow the device accessory, automatically based on planned upcoming events, and so forth.

In one or more embodiments, when a user (referred to as a borrower) desires to borrow a device, the desired device accessory determination module 202 receives (via the user interface module 210) any of a variety of different inputs from the borrower. The user input indicates which device accessory the borrower desires. The intelligent device accessory sharing system can be implemented on the borrower device as part of a stand-alone application that facilitates device accessory borrowing and lending. A user interface allowing the borrower to select a particular device accessory to borrow from a set of device accessories can be automatically presented to the user when the stand-alone application is run, or alternatively the user can input a command (e.g., selection of a button, an audible input, etc.) requesting that a set of device accessories be displayed or otherwise presented and the user can select from the device accessories in that set. Additionally or alternatively, the intelligent device accessory sharing system can be incorporated into an application providing additional functionality, such as a calendar application, a messaging application, a video conferencing application, and so forth. The user can input a command (e.g., selection of a button, an audible input, etc.) to the application requesting that a set of device accessories be displayed or otherwise presented and the user can select from the device accessories in that set.

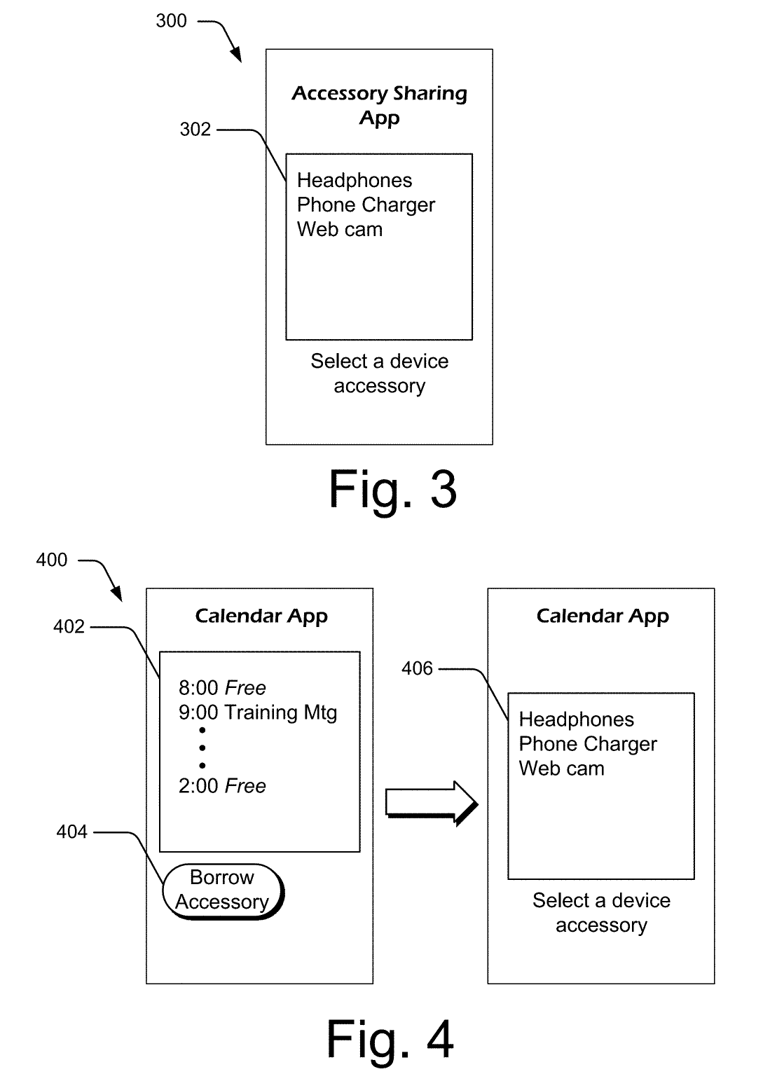

FIG. 3 illustrates an example user interface allowing user input to select a device accessory. A stand-alone application, the name of which is displayed as “Accessory Sharing App”, displays a user interface 300. The user interface 300 includes a list 302 of device accessories from which the user can select, which include headphones, phone charger, and Web cam in the illustrated example. The list 302 can be displayed automatically when the stand-alone application is run, or alternatively in response to a user input command for the stand-alone application to display the list 302. The user can select a device accessory on the list 302 by providing a variety of different user inputs as discussed above.

Although a single list 302 is displayed in the example of FIG. 3, it should be noted that one or more additional lists may be displayed. For example, the list 302 can be a set of categories of device accessories, and a category of device accessories may have a subset of multiple device accessories. E.g., the Web cam device accessory category may have a subset of multiple Web cams having different characteristics (e.g., a high resolution Web cam, a low resolution Web cam, a Web cam with a micro USB wired connection, a Web cam with a mini USB wired connection, etc.). In such situations, selection of a name of a device accessory in the list 302 can cause an additional list of device accessories having specific characteristics to be displayed. Such an additional list can itself have a subset of multiple device accessories that are displayed, and so forth.

FIG. 4 illustrates another example user interface allowing user input to select a device accessory. An application that provides additional functionality including calendaring functionality, the name of which is displayed as “Calendar App”, displays a user interface 400. The user interface 400 includes a calendar 402 as well as a button 404 that can be selected by the borrower to indicate a desire to borrow a device accessory and, optionally, a desired time period for borrowing the accessory. The borrower can select the button 404 by providing any of a variety of different user inputs as discussed above. In response to user selection of the button 404, a list 406 of device accessories from which the user can select is displayed, which include headphones, phone charger, and Web cam in the illustrated example. The user can select a device accessory on the list 406 by providing a variety of different user inputs as discussed above.

Returning to FIG. 2, the device accessories that are included in a list of device accessories displayed or otherwise presented by the borrower device 200 can be determined in any of a variety of different manners. In one or more embodiments, the desired device accessory determination module 202 includes or obtains a default list of device accessories. This default list can be, for example, device accessories that are expected by the designer or distributor of the intelligent device accessory sharing system to be commonly borrowed and lent among users. Additionally or alternatively, the desired device accessory determination module 202 can include on the list device accessories that are previously borrowed or requested to be borrowed by the borrower, device accessories that the borrower has specified (e.g., via a preferences or configuration option of the intelligent device accessory sharing system), device accessories that the user has previously coupled to the borrower device 200, and so forth.

Additionally or alternatively to user input requesting to borrow a device accessory, the desired device accessory determination module 202 can automatically determine that the user desires to borrow a device accessory. The desired device accessory determination module 202 makes this automatic determination based on various different information that the desired device accessory determination module 202 has regarding the user, the user's schedule, and the borrower device 200. Generally, the desired device accessory determination module 202 can determine that a particular device accessory will be desired by the user in the near future but that that particular device accessory is not coupled to the borrower device 200. For example, the desired device accessory determination module 202 can access a calendar of the user and determine that he or she has an upcoming video conference (e.g., within some threshold amount of time, such as half an hour) but no Web cam coupled to the borrower device 200. In this situation, the desired device accessory determination module 202 can automatically determine that the user desires to borrow the Web cam. Alternatively, the desired device accessory determination module 202 can automatically determine that the user is likely to desire the Web cam and display or otherwise present a notification to the user that he or she may desire the Web cam, and then determine that the user desires to borrow the Web cam in response to a user input selecting the Web cam (e.g., from a list of device accessories).

The desired device accessory determination module 202 communicates, to the first potential lender list generation module 204, an indication of the desired device accessory. The first potential lender list generation module 204 generates a first list of potential lenders of the desired device accessory based on the location of the borrower device 200 as well as locations associated with potential lenders. The location of the borrower device can be determined in various manners, such as by determining a geographic position of the borrower device 200 using a global navigation satellite system (GNSS) system (e.g., such as a global positioning system (GPS) module of the borrower device 200) and comparing the determined geographic position to known geographic positions (previously configured, e.g., automatically or by the user) for the user's workplace, home, and so forth.

Additionally or alternatively, the first potential lender list generation module 204 can monitor and use various other information describing the interactions the borrower has with other users, devices, or systems to determine the location of the user. This information can include which Wi-Fi or other local area network the borrower device 200 is logged into, which user account name the borrower has logged into the borrower device 200, which servers and/or services the borrower is logged into, and so forth. This information can also include information regarding which other users the borrower communicates with (e.g., via electronic mail, personal or corporate chat), social networks of the user, and so forth.

In one or more embodiments, the desired device accessory determination module 202 maintains information regarding different users that the borrower interacts with at different locations and those users are associated with those locations. These different locations can be, for example, home, office, gym, and so forth. This information can be maintained in various manners or records, such as in a contacts database of the user (e.g., maintained at the borrower device 200 and/or maintained at another device on behalf of the user). For example, if the borrower is in the office, the first potential lender list contains colleagues of the borrower that are also associated with the location of office. Interaction during a particular time duration (e.g., the past month) can be accessed to see which could be the borrower's friends in the office. Factors like the borrower's corporate account chats, the borrower's official group email members, the borrower's social network, and so forth can be used to prepare the first potential lender list. People or colleagues with whom the borrower had recent or the largest number of interactions can optionally be kept on top of the first potential lender list. While preparing the first potential lender list, the borrower's colleagues' calendars can optionally be accessed and those colleagues who are busy in meetings or other important activities at a time when the request is initiated can be excluded from the first potential lender list.

Additionally or alternatively, the locations associated with different users can be determined in other manners. In one or more embodiments, an application on the borrower device 200 is accessed to obtain the current locations of other users. The application itself may have knowledge of the current locations of other users and/or may obtain the current locations of other users from a remote service (e.g., accessed via the Internet). Such an application can be, for example, a social networking application to which the other users provide or otherwise make available their current locations. These current locations of the other users can be of various forms, such as geographic positions from a GPS system, geographic positions input by the other users, other locations (e.g., home, office, gym), and so forth.

Based on the location of the user at the time he or she desires the device accessory, first potential lender list generation module 204 includes those other users in the first list of potential lenders based on the locations associated with those other users. The first potential lender list generation module 204 includes other users that are associated with a location that is the same as the location of the user at the time he or she desires the device accessory are included on the first list of potential lenders. The first potential lender list generation module 204 can additionally or alternatively include on the first list of potential lenders other users that are logged into, have activated, or otherwise have agreed to participate in the intelligent device accessory sharing (e.g., those who have installed the stand-alone application).

Additionally or alternatively, the first potential lender list generation module 204 can use additional information available to the borrower device 200 in generating the first list of potential lenders. In one or more embodiments, the first potential lender list generation module 204 accesses a record of electronic mail messages that have been received by the borrower device 200. If those electronic mail messages indicate (e.g., in a tagline) a particular type of device, then the first potential lender list generation module 204 can include in the first list only those potential lenders that have a type of device that is compatible with the desired device accessory. For example, if the desired device accessory is a phone charger for an Android™ platform phone, if electronic mail messages received from a potential lender include a tagline of “Sent from my Android™ platform phone” then that potential lender is included in the first list. Continuing with this example, if electronic mail messages received from a potential lender include a tagline of “Sent from my Apple® brand phone” then that potential lender is not included in the first list.

It should be noted that this first list of potential lenders prepared by the first potential lender list generation module 204 need not, and typically is not, displayed or otherwise presented to the borrower. Rather, the borrower device 200 uses this first list of potential lenders as a background list.

The first potential lender list generation module 204 also sends, via the communication module 212, an enquiry to at least one (and typically all) of the devices of the potential lenders on the first potential lender list. In one or more embodiments the communication module 212 sends the enquiry using a communication protocol known to the intelligent device accessory sharing systems. The enquiry identifies the device accessory by a type, category, name, or combination thereof. For example, the enquiry includes an indication that a user desires to borrow a Web cam.

In one or more embodiments, the enquiry that the first potential lender list generation module 204 sends also identifies compatibility details of the borrower device 200. The compatibility details of the borrower device 200 refer to details regarding which device accessories would be compatible with (and thus would operate with) the borrower device 200. Device accessories of the same type can have various different characteristics, and not all device accessories of a particular type are compatible with a particular borrower device 200. For example, different Web cams are manufactured by different companies and have different software drivers that are installed on computing devices in order for the computing devices to communicate with the Web cams, different Web cams can have different cables designed to connect to computing devices via different types of ports (e.g., USB port, Mini DisplayPort, USB Type-C port, etc.), and so forth.

Various different compatibility details can be included in the enquiry. By way of example, the compatibility details can include a type of the borrower device 200, an operating system running on the borrower device 200, a type of the device accessory, a port of the borrower device 200 that the device accessory is to be coupled to (and/or that the device accessory is compatible with), information describing a driver for the device accessory that is available (e.g., already installed) on the borrower device 200, combinations thereof, and so forth.

The compatibility details can be obtained in any of a variety of different manners. In one or more embodiments, the operating system maintains a record or store of information that can be accessed to determine the compatibility details (e.g., the type of the borrower device 200 and/or the operating system running on the borrower device 200). Additionally or alternatively, the first potential lender list generation module 204 can monitor usage of device accessories on the borrower device 200 and automatically determine the compatibility details for device accessories at the borrower device 200. For example, when the user of the borrower device 200 couples a Web cam to the borrower device, the module 204 can determine the port that the Web cam is coupled to, the drivers the Web cam uses, and so forth. The module 204 maintains this information as the compatibility details for a Web cam. Additionally or alternatively, the first potential lender list generation module 204 receives user inputs specifying compatibility details for one or more device accessories.

In one or more embodiments, the enquiry sent by the first potential lender list generation module 204 also identifies an anticipated time and duration of use of the device accessory by the borrower device 200. The anticipated time and duration of use of the device accessory can be determined in a variety of different manners, such as by user input (e.g., the specifying when and/or for how long he or she desires to use the device accessory). The anticipated time and duration of use of the device accessory can also be determined automatically, such as based on calendar information of the borrower (e.g., the starting time and duration of a video conference for which the borrower desires to borrow a Web cam can be obtained from the borrower's calendar), based on previous device accessory usage (e.g., the amount of time taken to previously charge a user's phone can be used to indicate a duration of for borrowing a cell phone charger device accessory), and so forth.

For each potential lender device that receives the enquiry, the borrower device 200 receives an indication of whether the device accessory can be borrowed from the potential lender using the potential lender device. A potential lender device determines whether the device accessory can be borrowed based on one or both of whether a user of the potential lender device has the device accessory and whether the device accessory is available for lending by the user of the potential lender device, as discussed in more detail below. If a device accessory cannot be borrowed from a potential lender device, that potential lender device can return a response in the form of a “false” message or communication, a “no” message or communication, or other explicit indication that the device accessory cannot be borrowed from the potential lender device. Alternatively, if a device accessory cannot be borrowed from a potential lender device, the potential lender device can simply return no message or communication to the borrower device 200, which serves as an implicit indication that the device accessory cannot be borrowed from the potential lender device.

The first potential lender list generation module 204 communicates the indications received from the potential lenders to the second potential lender list generation module 206. The second potential lender list generation module 206 generates a second potential lender list, which is a list including zero or more potential lenders from which the device accessory can be borrowed. This includes, for example, potential lenders who have the device accessory attached to their device but are not using the device accessory and the potential lenders who recently used the device accessory but do not have it attached to the potential lender device presently. Potential lenders that are on the first list of potential lenders but from which the device accessory cannot be borrowed are not included on the second list of potential lenders.

The second potential lender list generation module 206 communicates the second list of potential lenders to the potential lender ranking module 208. The potential lender ranking module 208 ranks the potential lenders on the second list based on various different criteria and displays or otherwise presents names or other identifiers of the potential lenders on the second list in the order of the rankings. The second potential lender list generation module 206 can use various different criteria to rank potential lenders.

In one or more embodiments, the criteria used to rank potential lenders include a likelihood that the potential lender has the device accessory. Situations can arise in which a potential lender is identified as a potential lender from which the device accessory can be borrowed even though the potential lender does not currently have the device accessory. For example, if the potential lender last used the device accessory twenty minutes ago and the device accessory is not coupled to the potential lender device, the potential lender may be identified as a potential lender from which the device accessory can be borrowed. However, the potential lender may have already loaned the device accessory to another borrower (e.g., five minutes ago). Information to determine the likelihood that the potential lender has the device accessory can be received from the potential lender device as part of the response to the enquiry, such as information indicating whether the device accessory is currently coupled to the potential lender device, if the device accessory is not currently coupled to the potential lender device information indicating how long ago potential lender device last used the device accessory, and so forth. The potential lender can be deemed to have a higher likelihood of having the device accessory if the device accessory is currently coupled to the potential lender device than if the device accessory is not currently coupled to the potential lender device. Similarly, the potential lender can be deemed to have a higher likelihood of having the device accessory if the potential lender device last used the device accessory more recently than if the potential lender device last used the device accessory less recently. Potential lenders that are deemed to have a higher likelihood of having the device accessory are ranked higher than potential lenders that are deemed to have a lower likelihood of having the device accessory.

Additionally or alternatively, the criteria used to rank the potential lender devices can include a social network proximity of the potential lender to the borrower. The social network proximity of the potential lender to the borrower refers to how close the potential lender is to the borrower socially (e.g., how good a friend the potential lender is). This social network proximity can be determined in different manners, such as how close a friend the potential lender is deemed to be to the borrower (e.g., based on whether the potential lender is a friend of the user in a social network application or service, based on a number of email, chat, or other interactions the borrower has had with the potential lender over some time period (e.g., the past month)). This social network proximity can also be determined in other manners, such as whether the borrower has borrowed device accessories from the potential lender in the past, whether the potential lender has borrowed device accessories from the borrower in the past, whether the potential lender is included on a “contacts” list maintained by the borrower device, and so forth. Potential lenders that are deemed to be socially closer to the borrower are ranked higher than potential lenders that are deemed to be less close socially.

Additionally or alternatively, the criteria used to rank the potential lender devices can include a physical location of the potential lender. The physical location of the potential lender device can be determined by the potential lender device in any of a variety of different manners (e.g., analogous to the determination of the location of the borrower device 200 discussed above), and an indication of the physical location of the potential lender device can be received from the potential lender device as part of the response to the enquiry. Potential lenders that are deemed to be physically closer to the borrower are ranked higher than potential lenders that are deemed to be physically further from the borrower.

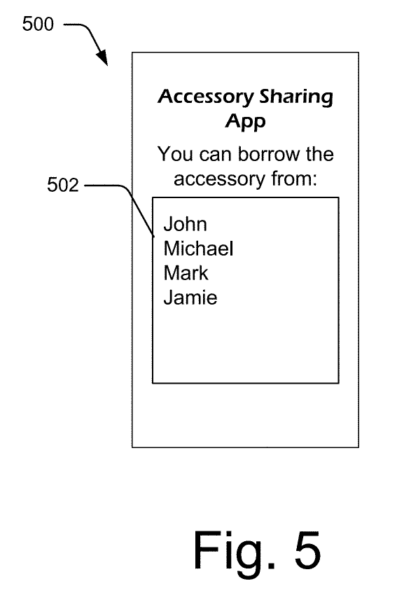

The potential lender ranking module 208 displays or otherwise presents names or other identifiers of the potential lenders on the second list in the order of the rankings (e.g., a list with the highest ranking potential lender on the top and the lowest ranking potential lender on the bottom). FIG. 5 illustrates an example user interface displaying names of potential lenders from which the desired device accessory can be borrowed. A stand-alone application, the name of which is displayed as “Accessory Sharing App”, displays a user interface 500. The user interface 500 includes a list 502 of potential lenders, shown as John, Michael, Mark, and Jamie. Potential lenders higher on the list 502 can be deemed to be more likely to have the device accessory than potential lenders lower on the list 502.

Returning to FIG. 2, the borrower can select a potential lender of his or her choice from the second list of potential lenders displayed by the potential lender ranking module 208. The borrower can then contact the selected potential lender in various manners, such as walking to the selected potential lender's desk, calling the potential lender on the phone, sending an email or other communication to the potential lender's device, and so forth.

FIG. 6 illustrates an example potential lender device 600 in accordance with one or more embodiments. The potential lender device 600 can be, for example, any of the computing devices 102, 104, 106, 108 of FIG. 1. The borrower device 600 is illustrated as being one of a smartphone 600-1, a computing watch 600-2, computing spectacles 600-3, a laptop 600-4, a tablet computer 600-5, and a desktop with a mouse 600-6, although the borrower device 600 can be other types of computing devices as discussed above.

The potential lender device 600 includes a requester verification module 602, an accessory availability verification module 604, a lending indication generation module 606, and a communication module 608. The modules 602, 604, 606 (and optionally the modules 608) together make up an intelligent device accessory sharing system of the potential lender device 600. Although not illustrated, the potential lender device 600 optionally includes a user interface module, analogous to user interface module 210 of the borrower device 200 of FIG. 2.

The communication module 608 provides functionality allowing the potential lender device 600 to communicate with other devices, such as borrower devices. The communication module 608 can support communication over various types of networks via a transceiver of the potential lender device 600, including direct wired and/or wireless communication couplings, as discussed above.

The requester verification module 602 verifies whether the user of the potential lender device 600 knows the requester of the device accessory. This requester can refer to the borrower and/or the borrower device from which the enquiry is received. The requester verification module 602 can determine which requesters the user of the potential lender device 600 knows in various manners, such as by maintaining a list of known users that can be updated manually by the potential lender. Additionally or alternatively, various rules or criteria can be applied to determine whether the potential lender knows the user. These rules or criteria can be based on the borrower's email address, the borrower's name, a physical device ID of the borrower device, and so forth. For example, the requester verification module 602 can determine that the potential lender knows the requester if the name of the borrower (e.g., as identified in the received enquiry) is included in a contacts list or database of the potential lender. By way of another example, the requester verification module 602 can determine that the potential lender knows the requester if the email address of the borrower (e.g., as identified in the received enquiry) has the same email domain as the email address of the potential lender. By way of yet another example, the requester verification module 602 can determine that the potential lender knows the requester if the potential lender and the borrower are both logged into the same Wi-Fi network or other service (e.g., both are currently logged into the same work service or domain).

If the requester verification module 602 determines that the potential lender does not know the requester, then the device accessory cannot be borrowed from the potential lender. However, if the requester verification module 602 determines that the potential lender does know the requester, then it is possible that the device accessory can be borrowed from the potential lender based on the determination made by the accessory availability verification module 604.

The accessory availability verification module 604 performs one or both of a matching device accessory check and a device accessory availability check. The matching device accessory check refers to determining whether the potential lender has the requested device accessory. The device accessory availability check refers to determining whether the device accessory is available for lending by the potential lender. In one or more embodiments, if one of the matching device accessory check and the device accessory availability check results in a determination that the device accessory cannot be borrowed from the potential lender, then the other of the matching device accessory check and the device accessory availability check need not be performed. For example, if borrowing of a Web cam is requested and the potential lender is currently in a video conference using a Web cam, then the requested Web cam is not available for lending by the potential lender and no check as to whether the Web cam satisfies the compatibility details of the enquiry need be made. By way of another example, if borrowing of a Web cam is requested and the potential lender has a Web cam that does not satisfy the compatibility details of the enquiry, then the potential lender does not have the requested Web cam and no check as to whether the potential lender's Web cam is available for lending need be made.

The matching device accessory check refers to determining whether the potential lender has the requested device accessory. The accessory availability verification module 604 can check any of a variety of different records, stores, lists, or other information on or available to the potential lender device 600, can send communications or otherwise sense the device accessory, and so forth to determine whether the potential lender has the requested device accessory. This check includes extracting compatibility details from the enquiry and checking that any compatibility details included in the enquiry are satisfied by the device accessory (e.g., the device accessory is compatible with any of the compatibility details included in the enquiry). In one or more embodiments, the operating system on the potential lender device 600 maintains a record or store of information that can be accessed by the accessory availability verification module 604 to determine whether the requested device accessory having the indicated compatibility details has been in the past (or is currently) coupled to the potential lender device 600. Additionally or alternatively, the accessory availability verification module 206 can check device accessory drivers installed on the potential lender device 600 to determine whether a driver specified in the compatibility details is installed on the potential lender device 600. If no driver specified in the compatibility details is installed on the potential lender device 600, then the accessory availability verification module 604 determines that the potential lender does not have the requested device accessory.

Additionally or alternatively, the accessory availability verification module 604 can access other information on or available to the potential lender device 600. In one or more embodiments, the accessory availability verification module 604 accesses and analyzes a record of electronic mail messages that have been sent from an electronic mail account that the potential lender device 600 is logged into. If those electronic mail messages indicate (e.g., in a tagline) a particular type of device, then the accessory availability verification module 604 can determine that the potential lender has device accessories associated with that type of device. For example, if electronic mail messages include a tagline of “Sent from my Android™ platform phone”, then the accessory availability verification module 604 can determine that the potential lender has a phone charger for an Android™ platform phone, but may not have a phone charger for an Apple® brand phone.

The device accessory availability check refers to determining whether the device accessory is available for lending by the potential lender. The accessory availability verification module 604 determines whether the device accessory is available for lending by the potential lender based on various use details of the device accessory. The accessory availability verification module 206 obtains these use details by analyzing various information available to the accessory availability verification module 604.

In one or more embodiments, the use details include information in a record or log (e.g., maintained by an operating system of the potential lender device 600) of which device accessories have been coupled to the potential lender device 600 and when (or if) those device accessories have been uncoupled from and/or accessed by the potential lender device 600. Additionally or alternatively, whether the device accessory is currently coupled to the potential lender device 600 can be sensed by the accessory availability verification module 604 without use of such a record or log (e.g., based on power drain from a port the device accessory is expected to be coupled to, based on data transmission from a port the device accessory is expected to be coupled to, by transmitting a request to and receiving a response from the device accessory, and so forth). Thus, the use details can include whether a device accessory is currently coupled to the potential lender device 600, how long ago a device accessory was last coupled to the potential lender device 600, how long ago the potential lender device 600 was last used a device accessory, and so forth. The borrower device can also use this information to rank potential lenders as discussed above.

Additionally or alternatively, the use details include information in a calendar or schedule of the potential lender. The accessory availability verification module 604 can use this information, along with anticipated time and duration of use information for the device accessory received as part of the enquiry, to determine whether the potential lender is expected to be using the device accessory during the time requested by the borrower. If the potential lender has an appointment scheduled for which the potential lender would use the device accessory and that conflicts with (e.g., overlaps in time, or is within a threshold amount of time of overlapping in time) the time requested by the borrower. For example, if the enquiry indicates a request for a Web cam starting in 30 minutes and for a duration of an hour, but analysis of the potential lender's calendar indicates that the potential lender has a video conference scheduled to begin in one hour, then the accessory availability verification module 604 determines that the device accessory is not available for lending by the potential lender.

Additionally or alternatively, the use details include information regarding power drain on one or more ports of the potential lender device 600 sensed by the accessory availability verification module 604. If a device accessory is coupled to a port of the potential lender device 600 and is currently extracting power from the potential lender device 600 via that port, then the accessory availability verification module 604 can determine that the device accessory is in use by the potential lender and not available for lending by the potential lender. For example, if the enquiry indicates a request for a mobile phone charger, and a mobile phone charger is coupled to a port of the potential lender device 600 and is drawing power from the potential lender device 600, the accessory availability verification module 604 can assume that the potential lender device 600 is using the mobile phone charger to charge a mobile phone of the potential lender and thus that the mobile phone charger is not available for lending by the potential lender.

Additionally or alternatively, the use details include information regarding data transmission on one or more ports of the potential lender device 600 sensed by the accessory availability verification module 604. If a device accessory is coupled to a port of the potential lender device 600 and is transmitting data from potential lender device 600 (or receiving data transmissions for the potential lender device 600) via that port, then the accessory availability verification module 604 can determine that the device accessory is in use by the potential lender and not available for lending by the potential lender.

The accessory availability verification module 604 communicates, to the lending indication generation module 606, an indication of whether the device accessory requested in the enquiry is available for lending by the potential lender. The lending indication generation module 606 generates and provides (e.g., via the communication module 608) an indication to the borrower device from which the enquiry was received of whether the device accessory is available for lending by (i.e., can be borrowed from) the potential lender. This indication provided to the borrower device optionally includes use details of the device accessory as determined by the accessory availability verification module 604 (e.g., when the potential lender device 600 last used the device accessory). This indication can be explicit or implicit as discussed above.

It should be noted that the potential lender device 600 need not notify the potential lender that a borrower is looking to borrow a particular device accessory. Alternatively, the potential lender device 600 can display or otherwise present to the potential lender an indication that the borrower is looking to borrow a particular device accessory.

Thus, it can be seen that when a borrower desires to borrow a device accessory, the borrower only contacts a person who has a high likelihood of having the device accessory and is not currently using the device accessory. The borrower does not disturb or interrupt other potential lenders with a request to borrow a device accessory that those other potential lenders do not have or are currently using. Furthermore, privacy intrusion or invasion is reduced or minimized because the borrower is presented with only the names of potential lenders from which he or she can borrow the device. Names of other potential lenders that do not have or are currently using the device accessory are not presented to the borrower.

Various different usage scenarios are supported by the intelligent device accessory sharing techniques discussed herein. By way of example, if a borrower desires to borrow a Web cam, the enquiry indicates that the borrower desires a Web cam, and the potential lender's device checks for a Web cam driver and compatibility details in the enquiry. The enquiry can include types of ports available on the borrower device for connecting the Web cam, operating system information, and so forth. After the potential lender device extracts this information, the potential lender device compares this information with the potential lender device's own state (e.g., present and recent past). The potential lender device checks whether the same or similar drivers are being accessed by any attached device accessory, whether a port to connect a Web cam is occupied, whether the port the Web cam uses is compatible with the port of the borrower device to which the Web cam would be coupled, whether a video session is active on the potential lender device, and so forth. If the port is occupied, drivers look compatible, the Web cam seems to be attached at the port, and no video session is active, then the potential lender device determines that the requested accessory Web cam is available for lending and is compatible with the borrower device. If the port is occupied, drivers look compatible, the Web cam seems to be attached at the port, but a video session is active, then the potential lender device determines that the requested accessory Web cam is not presently available for borrowing. If drivers look compatible, but the Web cam does not seem to be attached at the port, and no video session is active, then the potential lender device checks time stamps of the last access of the Web cam on the potential lender device based on drivers, port information, and so forth. E.g., if there had been a recent use (in the last one hour) of the Web cam at the potential lender device, the potential lender device determines that the compatible requested accessory is available for lending.

By way of another example, if a borrower desires to borrow a USB data cable for an Android™ platform phone, the enquiry indicates that the borrower desires a USB cable. In addition to the compatibility details discussed in the previous example, the borrower device checks the borrower's email to find potential lenders with “Sent from my Android™ platform phone” taglines. The potential lender device would thus check whether the USB port of the potential lender device is occupied, whether data is currently being transferred through the USB port, how recently data was last transferred through the USB port, whether an Android™ platform software suite is installed on the potential lender device, power drain through the USB port (indicating charging of the phone by the potential lender device), and so forth.

By way of another example, if headphones are desired by a borrower, the enquiry indicates that headphones are desired by the borrower. To determine if a potential lender is actually using their headphones or not, the potential lender device checks if any audio is being played on the potential lender's device. This can be checked based on types of Web browser open on the potential lender's Web browser, whether a video streaming Web site or application is active, whether a music app is active, whether the potential lender device volume is on mute or not, and so forth. If the device volume is muted and no video is being played on the device, the potential lender device determines that the headphones attached to the potential lender device are in an idle state and are available for lending. Another potential lender device that does not presently have headphones plugged into the potential lender device check the history of headphone use information on the potential lender device. How recently videos were played in the last hour, access to a video streaming Web site, and so forth can be taken into account to find potential lender who had used headphones recently (and are presumably carrying them now) but are not using them currently and are not currently attached to the potential lender device.

By way of yet another example, for other device accessories such as laptop computer chargers, pendrives, mice, keyboards, and so forth, suitable drivers, ports, programs, and so forth are checked by the potential lender device on receiving the enquiry to determine if a requested device accessory is available for borrowing from the potential lender.

### Example Methods

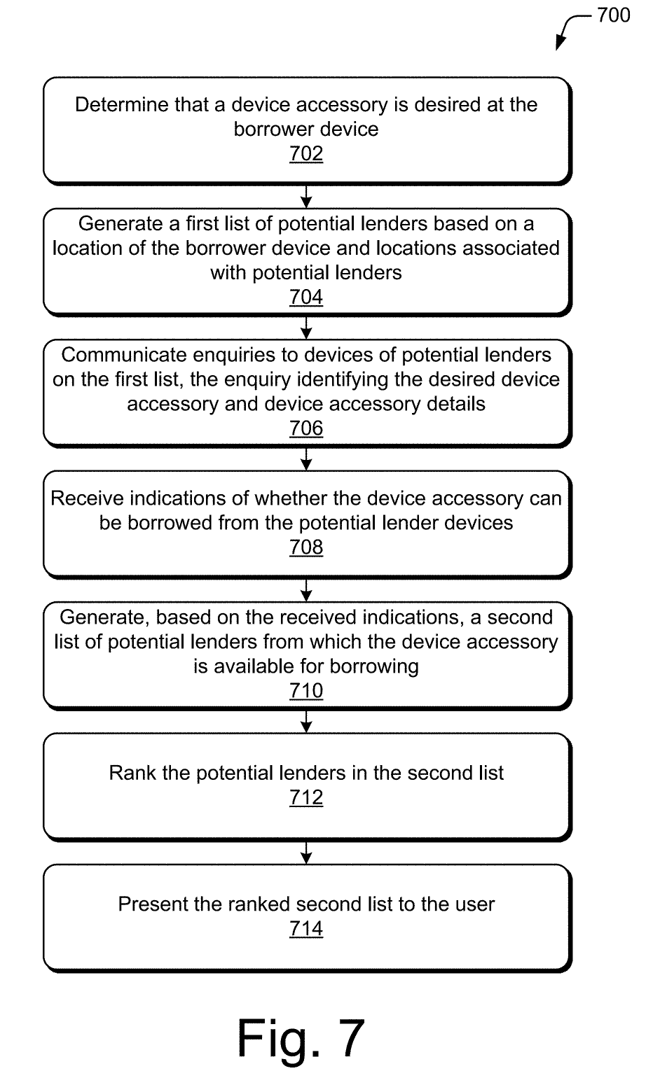

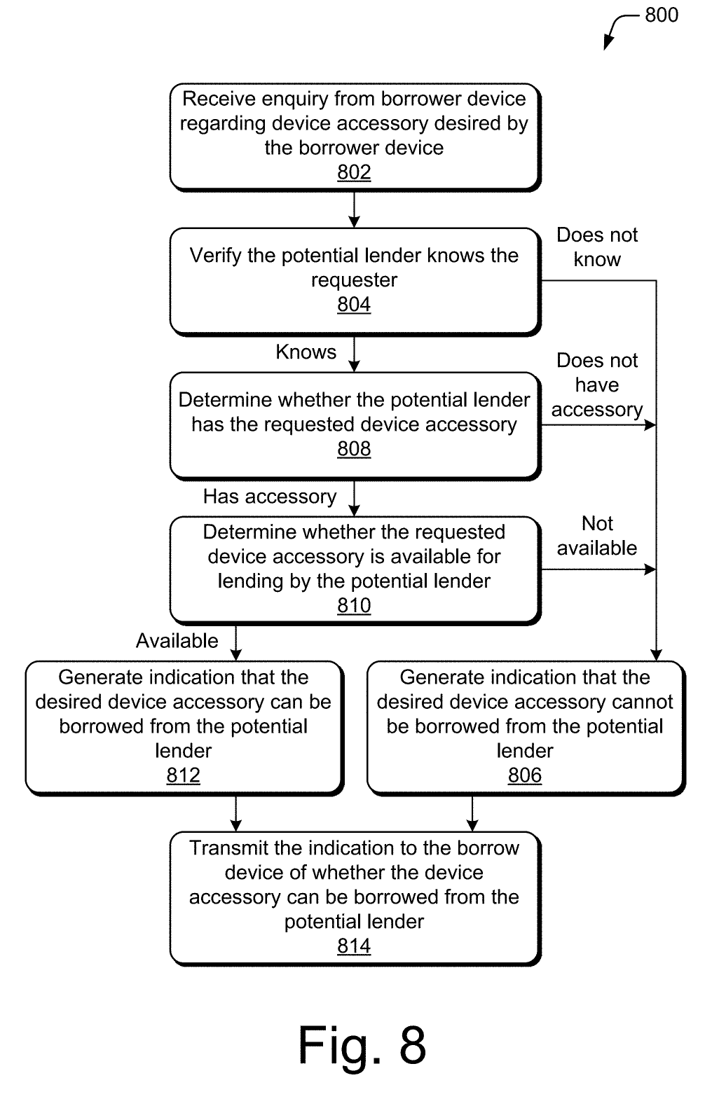

FIGS. 7 and 8 depict methods enabling or using intelligent device accessory sharing system in accordance with one or more embodiments. These methods are shown as sets of blocks that specify operations performed but are not necessarily limited to the order or combinations shown for performing the operations by the respective blocks. These operations can be performed in software, firmware, hardware, or combinations thereof.

FIG. 7 depicts a method 700, which describes operation of a borrower device in accordance with one or more embodiments.

The desired device accessory determination module 202 determines 702 that a device accessory is desired at the borrower device. The desired device accessory determination module can make this determination automatically, based on user input, and so forth as discussed above.

The first potential lender list generation module 204 generates 704 a first list of potential lenders based on a location of the borrower device and locations associated with potential lenders. Different potential lenders can be included on the first list for different locations of the borrower device. These different locations can be, for example, home, office, gym, and so forth.

The communication module 212 communicates 706 enquires to devices of potential lenders on the first list, also referred to as potential lender devices. The enquiry identifies the desired device accessory, and optionally identifies compatibility details of the device accessory and/or an anticipated time and duration of use of the device accessory by the borrower device as discussed above.

The communication module 212 receives 708 indications of whether the desired device accessory can be borrowed from the potential lender devices. These indications can be explicit indications or implicit indications as discussed above.

The second potential lender list generation module 206 generates 710, based on the received indications, a second list of potential lenders from which the device accessory is available for borrowing. The potential lenders on the second list are the users (potential lenders) of the potential lender devices that returned indications that the device accessory can be borrowed from the potential lender.

The potential lender ranking module 208 ranks 712, the potential lenders in the second list. The potential lender ranking module 208 can use various different rules or criteria to rank the potential lenders as discussed above, such as a likelihood that each potential lender has the device accessory, a social network proximity of the potential lender to the borrower, a physical location of the potential lender, and so forth.

The user interface module 210 displays or otherwise presents 714 the ranked second list of potential lenders. The borrower can then select a potential lender from the ranked second list of potential lenders as he or she desires, and communicate with the selected potential lender to borrow the desired device accessory.

FIG. 8 depicts a method 800, which describes operation of a potential lender device in accordance with one or more embodiments.

The communication module 608 receives 802 an enquiry regarding a device accessory desired by the borrower device from the borrower device. The enquiry identifies the desired device accessory, and optionally identifies compatibility details of the device accessory and/or an anticipated time and duration of use of the device accessory by the borrower device as discussed above.

The requester verification module 602 verifies 804 whether the potential lender knows the requester. The requester can be the borrower and/or the borrower device, as discussed above. The requester verification module 602 can perform this verification in various manners, such as based on a list of known users, other rules or criteria that are applied, and so forth as discussed above.

The lending indication generation module 606 generates 806, in response to determining that the potential lender does not know the requester, an indication that the desired device accessory cannot be borrowed from the potential lender.

The accessory availability verification module 604 determines 808 whether the potential lender has the requested device accessory. This is a matching device accessory check as discussed above.

The accessory availability verification module 604 determines 810 whether the requested device accessory is available for lending by the potential lender. This is a device accessory availability check as discussed above. The accessory availability verification module 604 can make the determinations at both 808 and 810, or alternatively make only one determination (at 808 or 810).

The lending indication generation module 606 generates 812, in response to verifying the potential lender knows the requester, determining that the potential lender has the requested device accessory, and determining that the requested device accessory is available for lending by the potential lender, an indication that the desired device accessory can be borrowed from the potential lender.

The lending indication generation module 606 generates 806, in response to determining that the potential lender does not have the requested device accessory and/or that the requested device accessory is not available for lending by the potential lender, an indication that the desired device accessory cannot be borrowed from the potential lender.

The communication module 608 transmits 814 the indication that is generated at either 806 or 812 to the borrower device. This indication transmitted is an indication to the borrower device whether the device accessory can be borrowed from the potential lender. Alternatively, if the desired device accessory cannot be borrowed from the potential lender, then the communication module 608 may transmit no indication to the borrower device at 814.

In one or more embodiments, the methods of FIGS. 7 and 8 can be repeated at regular or irregular intervals. For example, if the second list of potential lenders includes no lenders, or the borrower has not yet borrowed the device accessory from a potential lender, the methods of FIGS. 7 and 8 can be repeated after some duration of time (e.g., ten minutes). Thus, the borrower device can repeatedly send enquiries to see if a device accessory has become available for lending. This repeated enquiry sending can be performed for various durations of time, which can be set by user input, can be a default duration of time, or can be automatically determined. For example, if the borrower has a video conference (according to his or her calendar) coming up in thirty minutes, enquiries can be repeatedly sent until the video conference begins. However, after the video conference begins, the sending of these enquiries can cease.

### Example Computing System

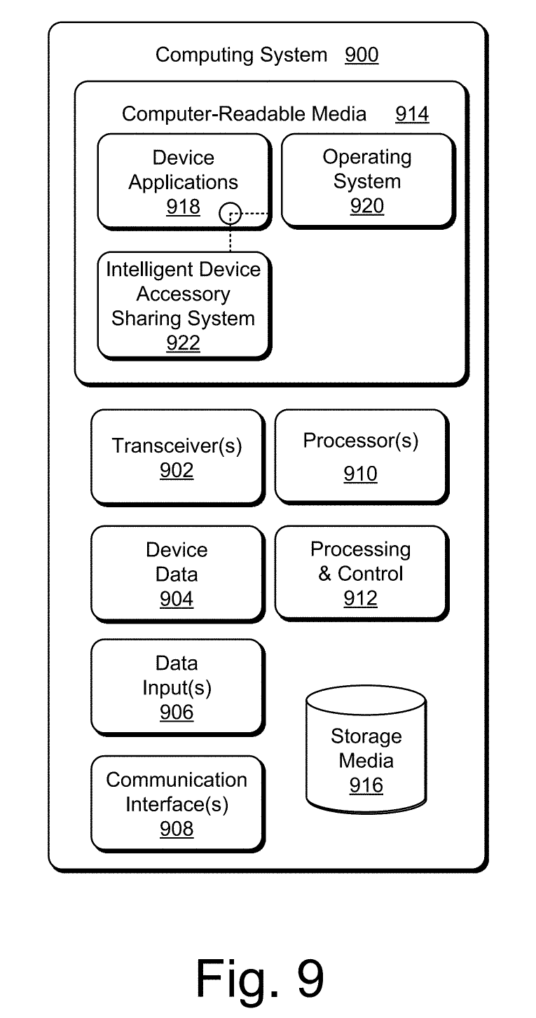

FIG. 9 illustrates various components of example computing system 900 that can be implemented as any type of computing device as described with reference to the previous FIGS. 1-8 to intelligent device accessory sharing system. In embodiments, the computing system 900 can be implemented as one or a combination of a wired and/or wireless wearable device, System-on-Chip (SoC), and/or as another type of device or portion thereof. The computing system 900 may also be associated with a user (e.g., a person) and/or an entity that operates the device such that a device describes logical devices that include users, software, firmware, and/or a combination of devices.

The computing system 900 includes one or more transceivers 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on the computing system 900 can include any type of audio, video, and/or image data, including complex or detailed results of automated nursing assessment acts. The computing system 900 includes one or more data inputs 906 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 900 also includes communication interfaces 908, which can be implemented as any one or more of a serial and/or parallel interface, a wireless interface, any type of network interface, a modem, and as any other type of communication interface. The communication interfaces 908 provide a connection and/or communication links between the computing system 900 and a communication network by which other electronic, computing, and communication devices communicate data with the computing system 900.

The computing system 900 includes one or more processors 910 (e.g., any of microprocessors, controllers, and the like), which process various computer-executable instructions to control the operation of the computing system 900 and to enable techniques for, or in which can be embodied, an intelligent device accessory sharing system. Alternatively or in addition, the computing system 900 can be implemented with any one or combination of hardware, firmware, or fixed logic circuitry that is implemented in connection with processing and control circuits which are generally identified at 912. Although not shown, the computing system 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 900 also includes computer-readable media 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. The computing system 900 can also include a mass storage media device 916.

The computer-readable media 914 provides data storage mechanisms to store the device data 904, as well as various device applications 918 and any other types of information and/or data related to operational aspects of the computing system 900. For example, an operating system 920 can be maintained as a computer application with the computer-readable media 914 and executed on the processors 910. The device applications 918 may include a device manager, such as any form of a control application, software application, signal-processing and control module, code that is native to a particular device, a hardware abstraction layer for a particular device, and so on.

The device applications 918 also include any system components, engines, or managers to implement the intelligent device accessory sharing system techniques discussed herein. In this example, the device applications 918 include the intelligent device accessory sharing system 922. The intelligent device accessory sharing system 922 can be, for example, any of the intelligent device accessory sharing systems 112, 114, 116, or 118 discussed above, an intelligent device accessory sharing system of the borrower device 200 discussed above, or the potential lender device 600 of FIG. 6 discussed above.

### CONCLUSION

Although embodiments of techniques using, and apparatuses enabling, intelligent device accessory sharing have been described in language specific to features and/or methods, it is to be understood that the subject of the appended claims is not necessarily limited to the specific features or methods described. Rather, the specific features and methods are disclosed as example implementations of these techniques.

What is claimed is:

1. A method in a computing device, the method comprising:
determining that a device accessory is desired at the computing device;
generating a first list of potential lenders based at least in part on a location of the computing device and locations associated with potential lenders;
communicating, for each potential lender on the first list, an enquiry to a device of the potential lender, the enquiry identifying the device accessory;
receiving, from at least one of the potential lender devices, an indication of whether the device accessory can be borrowed from the potential lender;
generating a second list of potential lenders based at least in part on the received at least one indication; and
presenting, at the computing device, an identifier of at least one of the potential lenders on the second list.

2. The method as described in claim 1, wherein the determining comprises:
receiving a user selection of the device accessory from a device accessory list.

3. The method as described in claim 1, wherein the determining comprises:
detecting that the device accessory is expected to be used during a future calendar event and sensing that the device accessory is not currently coupled to the computing device.

4. The method as described in claim 1, wherein the generating the first list of potential lenders comprises:
obtaining a location of at least one of the potential lenders from a contacts database of a user of the computing device or a social networking application on the computing device, the contacts database including an indication of home or office for at least one of the potential lenders, the social networking application including GPS geographic positions for at least one of the potential lenders.

5. The method as described in claim 1, the communicating the enquiry further comprises:
identifying at least one compatibility detail of the device accessory, the at least one compatibility detail selected from the group including: a type of the computing device, an operating system running on the computing device, a type of the device accessory, a port of the computing device that the device accessory is to be coupled to, and information describing a driver for the device accessory that is available on the computing device.

6. The method as described in claim 1, the communicating the enquiry further comprising:
identifying an anticipated time and duration of use of the device accessory by the computing device.

7. The method as described in claim 1, the method further comprising:
ranking the potential lenders on the second list according to one or more criteria that include a likelihood, for each of the potential lenders on the second list, of the potential lender still having the device accessory,
wherein the presenting further comprises
presenting identifiers of the potential lenders on the second list in order of the rankings.

8. The method as described in claim 1, the method further comprising:
ranking the potential lenders on the second list according to one or more criteria that include, for each of the potential lenders on the second list, a social network proximity of the potential lender to a user of the computing device,
wherein the presenting further comprises:
presenting identifiers of the potential lenders on the second list in order of the rankings.

9. A method in a computing device, the method comprising:
receiving an enquiry from a borrower device, the enquiry identifying a device accessory desired by the borrower device;
automatically determining, in response to the enquiry, one or both of whether a user of the computing device has the device accessory and whether the device accessory is available for lending by the user; and
transmitting, to the borrower device, an indication that the device accessory can be borrowed from the user in response to determining that the user has the device accessory and that the device accessory is available for lending by the user.

10. The method as described in claim 9, wherein the automatically determining comprises:
extracting at least one compatibility detail of the device accessory from the enquiry, the at least one compatibility detail selected from the group including: a type of the borrower device, an operating system running on the borrower device, a type of the device accessory, an available port of the borrower device compatible with the device accessory, and information describing a driver available on the borrower device for the device accessory.

11. The method as described in claim 9, wherein the automatically determining comprises:
analyzing electronic mail messages sent from the computing device.

12. The method as described in claim 9, wherein the automatically determining comprises:
sensing whether the device accessory is currently coupled to the computing device.

13. The method as described in claim 9, wherein the automatically determining comprises:
determining how recently the device accessory was used by the computing device.

14. The method as described in claim 9, wherein the receiving an inquiry comprises:
receiving an indication of an anticipated time and duration of use of the device accessory by the borrower device; and
wherein the automatically determining comprises:
analyzing details of the device accessory including whether the device accessory is expected to be used by the computing device during the anticipated time and duration of use of the device accessory by the borrower device.

15. The method as described in claim 14, wherein the analyzing details of the device accessory comprises:
analyzing a calendar of the user; and
determining that the device accessory is expected to be used by the computing device during the anticipated time and duration of use of the device accessory by the borrower device if the calendar of the user indicates that the user has an appointment for which the user would use the device accessory and that overlaps in time with the anticipated time and duration of use by the device accessory by the borrower device.

16. The method as described in claim 9, wherein the automatically determining comprises:
sensing use details of the device accessory including a power drain or data transmission from a port of the computing device to which the device accessory is currently coupled.

17. The method as described in claim 9, further comprising:
transmitting, to the borrower device, an indication that the device accessory cannot be borrowed from the user in response to determining that the device accessory is unavailable for lending by the user.

18. The method as described in claim 9, the method further comprising:
verifying whether the user knows the requester, the user knowing the requester if an identifier of the requester is included in a contacts list of the user;
performing the determining and transmitting in response to the user knowing the requester; and
transmitting an indication that the device cannot be borrowed from the user in response to the user not knowing the requester.

19. A computing device comprising:
a computer processor;
a transceiver configured to receive an enquiry from a borrower device, the enquiry identifying a device accessory desired by the borrower device; and
a computer-readable storage medium comprising instructions stored thereon that, responsive to execution by the computer processor, implement an intelligent device accessory sharing system configured to:
automatically determine, in response to the enquiry, one or both of whether a user of the computing device has the device accessory and whether the device accessory is available for lending by the user; and
transmit to the borrower device, via the transceiver, an indication of whether the device accessory can be borrowed from the user, the indication including
an indication that the device accessory can be borrowed from the user in response to determining that the user has the device accessory and that the device accessory is available for lending by the user, and
an indication that the device accessory cannot be borrowed from the user in response to determining that the device accessory is unavailable for lending by the user.

20. The computing device as described in claim 19, wherein the intelligent device accessory sharing system is further configured to extract at least one compatibility detail of the device accessory from the enquiry, the at least one compatibility detail selected from the group including: a type of the borrower device, an operating system running on the borrower device, a type of the device accessory, an available port of the borrower device compatible with the device accessory, and information describing a driver available on the borrower device for the device accessory.
